(19) United States
(12) Patent Application Publication
(10) Pub. No.: US 2018/0289579 A1
(43) Pub. Date: Oct. 11, 2018

(54) Powered Walking Assistant and Associated Systems and Methods

(71) Applicant: The Trustees of Columbia University in the City of New York, New York, NY (US)

(72) Inventor: Sunil K. AGRAWAL, Newark, DE (US)

(73) Assignee: The Trustees of Columbia University in the City of New York, New York, NY (US)

(21) Appl. No.: 15/950,946

(22) Filed: Apr. 11, 2018

Related U.S. Application Data
(60) Provisional application No. 62/484,170, filed on Apr. 11, 2017.

(51) Int. Cl. A61H 3/00; A61H 3/04

(52) U.S. Cl. CPC A61H 3/008; A61H 3/04; A61H 2003/007; A61H 2201/0192; A61H 2003/046; A61H 2201/163; A61H 2003/043; A61H 2201/1657

(57) ABSTRACT

A robotic assistant provides active support for disabled users and may take the approximate form of a cane or a walker.

### CROSS-REFERENCE TO RELATED APPLICATIONS

This application claims priority to and the benefit of U.S. Provisional Application No. 62/484,170 filed Apr. 11, 2017, the content of which is incorporated herein by reference in its entirety.

### BACKGROUND

As many as 12 million Americans have mobility limitations and 6.4 million of these use assistive devices for mobility. A variety of factors and pathologies contribute to mobility impairments, including healthy or diseased ageing, arthritis, cardiovascular incidents, spinal cord injury, vestibular disorder, pain, and trauma, among others. Mobility impairments represent a major obstacle for the elderly as gait and balance dysfunction affect 14% of people aged 65 to 74. Many elderly people also suffer from physical and cognitive decline, requiring active supervision and assistance during typical daily activities, including walking. Additionally, existing walking aids are unsafe, as 47,000 Americans annually report a fall while using these walking aids. Robotic assistants and caregivers can reduce the economic cost of and burden on human caregivers and make patients feel more self-sufficient. There is a need to study how ‘traditional walking aids’ can be redesigned to become intelligent ‘walking assistants’ that act as companions, active support devices, and rehabilitation aids, as required by their users.

### SUMMARY

A modular scalable customizable walking assistant augments the capability of elderly people in their activities of daily life. The walking assistants can provide ubiquitous access to rehabilitative training outside of the clinic. Walking assistants are effective in a variety of situations and can be customized as: (i) a wheeled mobile unit that serves as a companion and as a monitor during daily activities, (ii) a programmable arm on a mobile base to provide the functions of an intelligent cane, and (iii) a mobile walker with active pelvic support to assist those with gait deficits. The control of these walking assistants may be customized to suit the needs of a user by monitoring their kinematics, ground interactions and environment data collected from sensors embedded within the walking assistants. The disclosed walking assistance devices may serve as companions, safety monitors, and rehabilitation devices for those with gait and balance deficits. The walking assistants may be networked with other walking assistants and personnel in a facility. The disclosed embodiments address various issues such as (i) control of the wheeled companion using sensed data from the user (ii) control of the wheeled mobile cane to facilitate and improve human balance (iii) and augmentation of human balance using a walker with cable-driven pelvic assist device and (iv) extract data from user inputs.

Falls and fall-related injuries are the most common and serious problems among those with balance deficits, especially in late life. Given the demographic shift towards increasing life expectancy worldwide, there may be a shortage of caregivers to assist the elderly. The proposed walking assistants can bridge this personnel gap to impact millions of Americans who have deficits in walking and require constant supervision.

### BRIEF DESCRIPTION OF THE DRAWINGS

Embodiments may hereinafter be described in detail below with reference to the accompanying drawings, wherein like reference numerals represent like elements. The accompanying drawings have not necessarily been drawn to scale. Where applicable, some features may not be illustrated to assist in the description of underlying features.

FIG. 1A shows a conventional cane and a walker according to the prior art.

FIG. 1B is a schematic that shows how a cane can increase the base of support during standing and walking with panels 1-5 showing the cane held contralateral to affected limb: (1) stationary standing; (2) triple support with cane applying braking force during the heel strike of the affected leg; (3) affected limb in stance while the sound leg in swing; (4) triple support with cane generating propulsive force during early heel strike of the unaffected leg; (5) standing on sound limb.

FIGS. 2A and 2B show a walk-assist robot that provides navigation and control based on the framework of differential flatness.

FIGS. 3A and 3B show a distributed force sensor on a grip handle for a grip of the walk assist robot of FIGS. 2A and 2B.

FIG. 3C shows the parts of the mapping of the force sensors of the grip handles of FIG. 3A to parts of a user's hands.

FIGS. 4A through 4D show various images and details of SoleSound instrumented footwear.

FIG. 4E shows a result of an application of a convolutional neural network on data collected with SoleSound.

FIGS. 5A and 5B show two types of pelvic assist active therapy devices.

FIGS. 6A and 6A′ shows a support assist robot.

FIGS. 6B through 6H and 6J show images relating to a study of support experiments using various assist devices.

FIG. 7 shows instrumented forearm crutches.

FIGS. 8A through 8E show configurations of different assistive devices that may be created from a shared set of modules.

FIGS. 9 through 11 are diagrams for purpose of discussing control schemes of various assistive device embodiments, respectively.

FIG. 12 shows a schematic of a following algorithm example for an assistive device embodiment.

FIG. 13 summarizes a control and analysis schema.

### DESCRIPTION

Conventional Geriatric Walking Aids: Mobility aids, such as canes, walkers, and crutches, are often used by older adults who have balance and gait deficits. Balance during walking involves regulating the body center of mass to keep it within the instantaneous base of support. The use of mobility aids, such as a cane or a walker, can increase the base of support during walking and can also be used to exert desired forces on the ground. As a result, a user can tolerate larger perturbations of the center of mass.

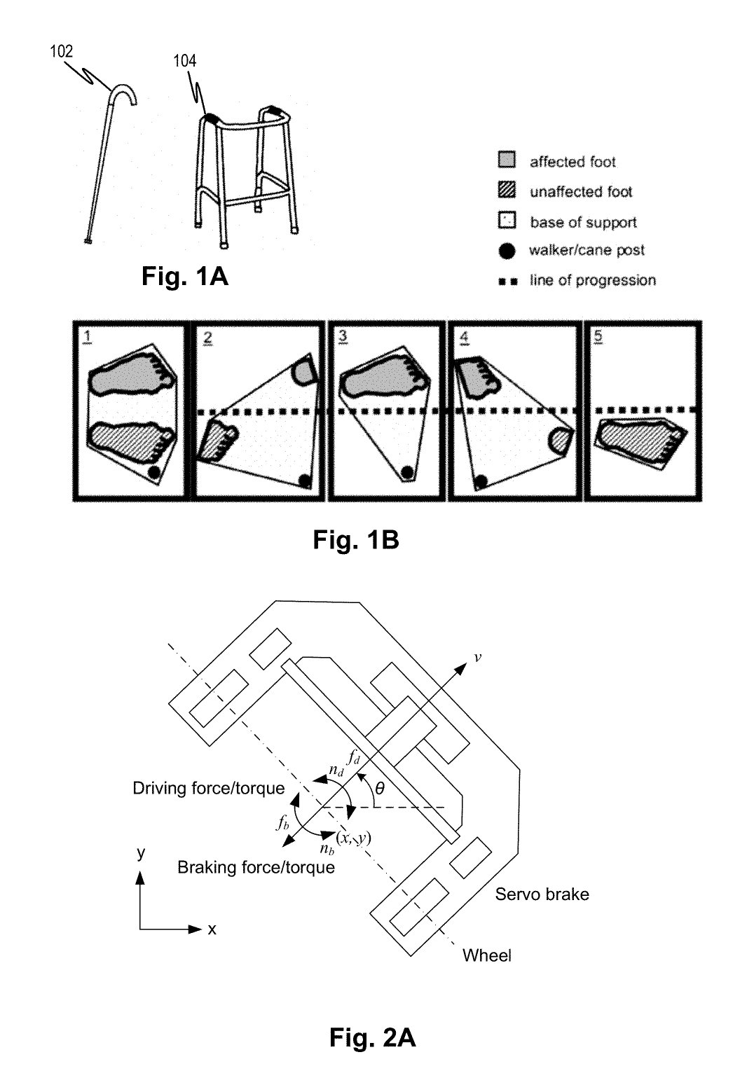

FIG. 1A shows a conventional cane 102 and a walker 104. FIG. 1B shows how the base of support can be increased and the position of the center of mass can be modulated as a person walks with a cane placed on the opposite side of a weak leg or affected foot. In addition, the cane can be used to generate propulsive and/or braking forces during walking to regulate the fore-aft component of the ground reaction force. The subjects can modulate their body posture using the cane so that the center of mass can be kept within the base of support. These allow the user to have better control during a gait cycle. FIG. 1B panel (2) shows late swing and early heel strike of the weak leg, during which braking forces can be applied by the cane. Panel (4) shows late stance and toe-off of the affected leg, during which propulsive forces can be applied by the cane. Canes are typically light weight and those using canes often report improved confidence, and increased levels of activity, feelings of safety, and independence.

Walkers function like canes by increasing the base of support. However, most walkers are heavy and are difficult to maneuver. Some walkers have wheels in the front to facilitate maneuverability while walking. Walkers also result in poor back posture and reduced arm swing. Crutches are used under the armpits or over the forearms to bear weight of the body during walking. These are typically used by those who have bilateral deficits but have a stronger upper arm. Crutches require upper body strength and are energetically expensive. Those who require crutches get tired easily, hence crutches are typically avoided by the frail or the elderly.

Challenges while using Conventional Canes and Walkers: Despite their relative simplicity in design and decades of use, there are many issues which make the use of canes and walkers challenging for those with balance deficits. The use of these devices during ambulation requires: (a) periodic lifting/rolling and advancing of the device, (b) choosing appropriate contact locations on the ground, (c) synchronizing the motion of the device with the body movement, (d) modulating the force and moment applied by the hands on the device during movement, and (e) avoiding collision of the walking aid with lower limbs and/or objects in the environment. While these tasks may seem trivial for the able bodied, they are not so easy for those with balance deficits. These tasks place significant attentional demands on the central nervous system and the neuro-motor control. As a result, falls with walking aids are frequent. In the U.S., an estimated 47,300 users fall every year while using walking aids and are treated for injuries.

The disclosed subject matter includes technology related to balance augmentation during walking using smart canes or walkers that overcome limitations of conventional and prior intelligent walking aids and overcome them by changing them into safe and intelligent walking assistants using the framework of robotics with integrated sensing, computation, communication, and control. The resulting walking assistants may serve as intelligent companions, active support devices, and rehabilitation therapists, as needed. These assistants may be networked with other walking assistants and long-term care personnel. In addition to the typical issues of systems and control design in robotics, the algorithms for intelligent walking assistants include (i) biomechanical limitations of the user, (ii) physical support and guidance requirements during walking tasks, and (iii) neuro-motor control ability of the user. For the system to be suitable for the long-term care centers and their residents, a user-centric design may employ where the design evolves with continuous feedback from the end users. The embodiments may employ features and technology from existing and other systems.

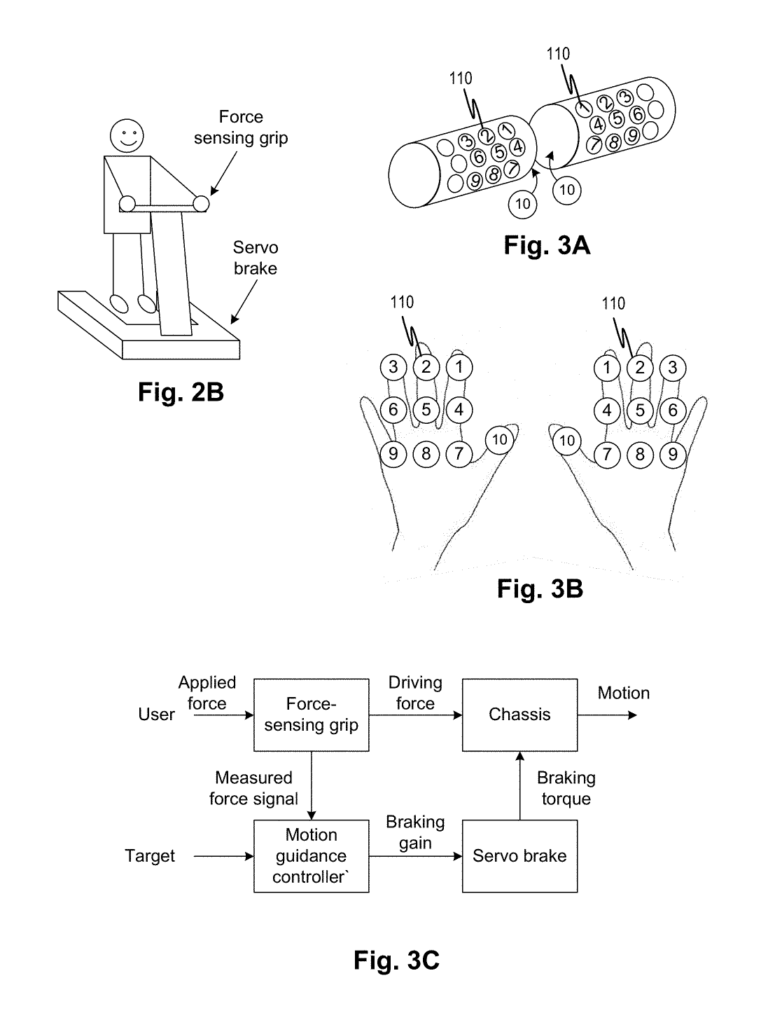

Navigation and control of walk-assist robots may use the framework of differential flatness. FIG. 2B shows a picture of a walk-assist robot and FIG. 2A shows a schematic of the system that was used to make the differentially driven kinematic and dynamic model of the vehicle. FIG. 3A shows a distributed force sensor on a grip handle of the walk assist robot of FIGS. 2A and 2B. Referring to FIGS. 3A and 3B, multiple individual force sensors 110 (numbered 1-9) are arrayed on each grip with hand placement relative to the force sensors being indicated in FIG. 3B.

FIG. 3B shows the parts of the mapping of the force sensors to the parts of a user's hands. FIG. 3B shows one of the control schemes that was implemented and tested. The system was tested in both passive and active control modes for guidance of a robot walking helper. The passive mode used a braking control law on the wheels to differentially steer the vehicle whereas the active mode was used to compensate for gravity when a user pushed the walker uphill. The system consists of a support frame, two wheels driven by motors with encoders, two passive casters, a force sensor, a slope sensor and a pc-based controller. The support frame has a semi-enclosed design that allows the user to walk at the center of the helper with good support around him. The motors provide the torques for controlling the motion of the robot. The encoders measure the wheel speed, the force sensor detects the user-applied force and the slope sensor detects the slope angle. The motor control torques are obtained by combining braking and active torque. Since the robot applies the active torque to help in human walking, the user-applied forces during uphill walking was reduced. The integrated active-passive method for control improves both the safety and energy usage of the robot compared to a fully active control. Furthermore, the differential flatness approach solves both the trajectory planning and control problems within a common mathematical framework. The systems were tested in a series of experiments conducted with young and elderly users, demonstrating the effectiveness of the system.

A system (called “SoleSound”) may combine a walker as described above, for example, with additional inputs and feedback provided by shoes that characterize spatiotemporal gait parameters. SoleSound was designed at the ROAR Laboratory. It consists of right and left footwear units and a hip pack unit. Compared to existing instrumented footwear, it measures a more complete set of intra- and inter-limb gait parameters. These include: stride length, foot-ground clearance, base of walking, foot trajectory, ankle plantar-dorsiflexion angle, cadence, single and double support, symmetry ratios, and walking speed. The device is fully portable and does not require any external equipment. SoleSound can optionally deliver auditory and vibrotactile feedback in response to the measured gait parameters. The total weight of the components attached to each sandal is 190 grams, and the weight of the hip pack unit is 1.14 kg. The full system can be donned in less than 5 minutes without assistance. The data can be gathered at around 500 Hz.

Accuracy and precision: SoleSound was assessed under different calibration strategies: subject-specific and generic using data from 14 healthy individuals who walked with SoleSound for 15 minutes. The results indicated that the estimates of stride length, foot ground clearance and ankle dorsiflexion angle either outperformed or were in line with those of similar footwear-based devices which, nonetheless, use professional-grade sensors. The base of walking—a key inter-limb parameter to assess the user's balance—was estimated with superior accuracy than reported in previous works. Overall, the accuracy obtained with SoleSound indicates that this footwear-based system may be a valid alternative to specialized laboratory equipment for quantitative gait assessments.

Clinical Gait Assessments: Gait analysis capability of SoleSound has been applied to multiple clinical populations: community-dwelling adults without known gait impairments, residents of assisted living facilities, adults with a complaint of dizziness, those with vestibular lesions such as acoustic neuroma, neurodegenerative disorders such as Parkinson's, spinal muscle atrophy, and others. Thus far, these assessments have involved over 300 individuals who performed multiple tasks using SoleSound, such as walking over ground on hard and padded surfaces, stair negotiation, sit to stand, single leg stance, and others. The shoes were also used to collect gait data from more than 150 elderly subjects living in Atria Living facilities in New York City metropolitan area. Many of these were elders who use walking aids such as canes and walkers.

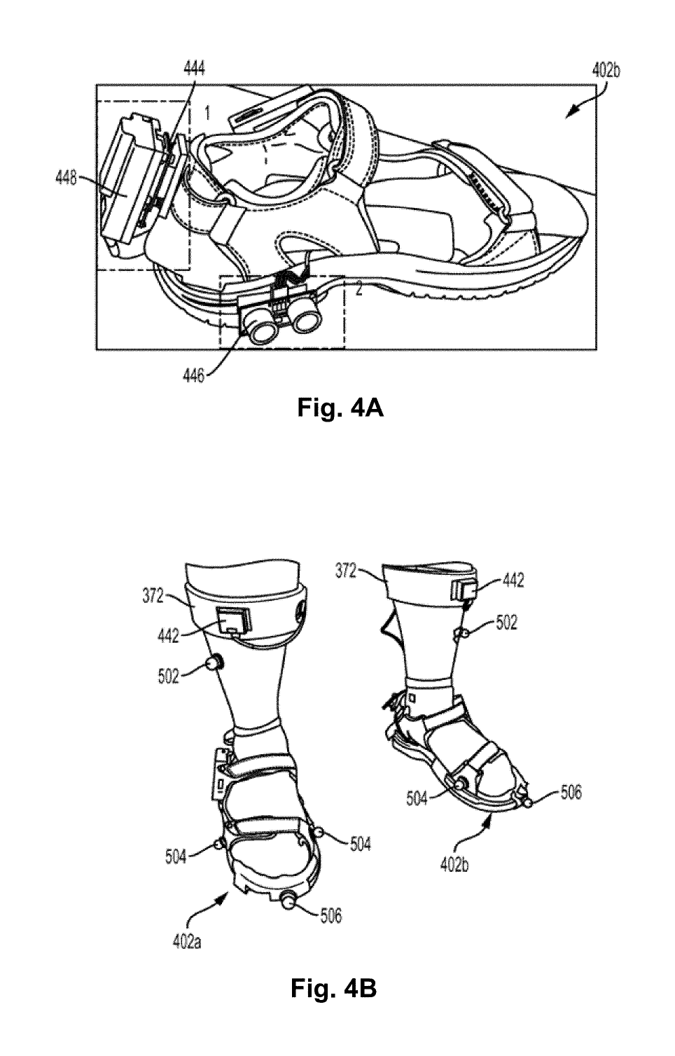

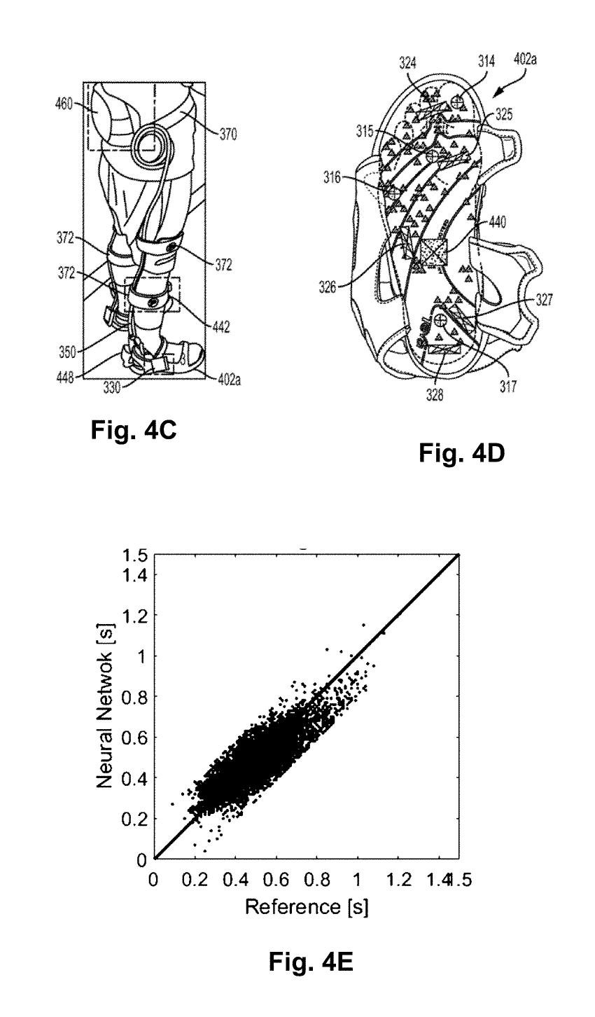

SoleSound is described in US Patent Publication US 2017-0055880, which is hereby incorporated fully in its entirety herein. There are three benefits of the device based on user feedback: (i) Subjects prefer to wear their own shoes as opposed to a new sandal given to them. Hence, it is desirable to insert an insole in their shoes. The electronics within the insole should be such that the wires do not break, requiring frequent repairs. Hence, conductive threads were used instead of standard wires within insole electronics. (ii) Often older subjects or patients with abnormal gait strike the heel or the toes during walking at various locations on their foot when compared to typical healthy subjects. Hence, the pressure sensors within the insoles should be sensitive over a distributed area as opposed to discrete locations. SoleSound, one can measure underfoot pressure even in children with cerebral palsy who walk while bearing weight at the inner or outer edges of the sole of the foot. (iii) The analysis of 6-minute walking data with SoleSound required close to six hours by an experienced engineer to visually look at the data, discard abnormal gait cycles, and then perform the analysis. Healthy subjects have a high degree of periodicity in their data which minimizes the need for processing by an analyst. However, subjects with gait and balance deficits show much more variability in their recorded signals. Hence, there is a need for machine learning methods to accurately compute gait characteristics in near real-time using the raw data acquired from the sensors. FIG. 4A shows side view of a SoleSound footwear. Tracking was performed using reflective markers as shown in FIG. 4B. FIG. 4C shows the system as worn by a subject. FIG. 4D is a bottom view of the system. FIG. 4E shows a result using convolutional neural network where data from 150 elderly subjects collected with SoleSound was used to train a network that identifies gait parameters in near real-time. The network uses raw data collected using the sensors on the shoes. Elements: a microcontroller 444; 3-axis accelerometer 448; base doppler sensor 446; footwear unit 402a, b; leg straps; shank IMU; processing module 460 attached to the belt 370; markers 501, 504; vibrotactile transducers 324-328. Each footwear module 302 may include at least four regions 304-307 with at least one sensing component and at least one feedback component therein. For example, a first region 304 under the hallux distal phalanx of the foot includes a first piezo-resistive sensor 314 and a first vibro-transducer 324, a second region 305 under the first metatarsal head of the foot includes a second piezo-resistive sensor 315 and a second vibro-transducer 325, a third region 306 extending under the mid lateral arch and the fourth metatarsal head of the foot includes a third piezo-resistive sensor 316 and a third vibro-transducer 326, and a fourth region 307 under the calcaneus includes a fourth piezo-resistive sensor 317, a fourth vibro-transducer 327, and a fifth vibro-transducer 328. The five vibrotactile transducers 324-328 may be embedded in the sole of the footwear unit 302. The location of the transducers 324-328 may be optimized to match the sole areas where the density of mechanoreceptors is higher.

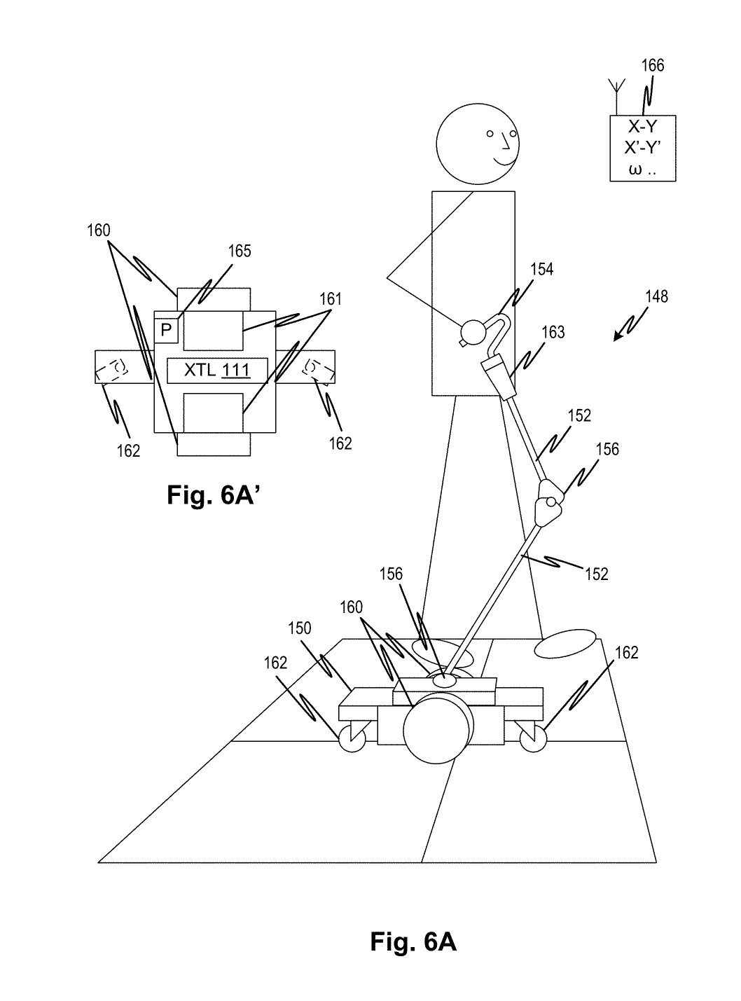

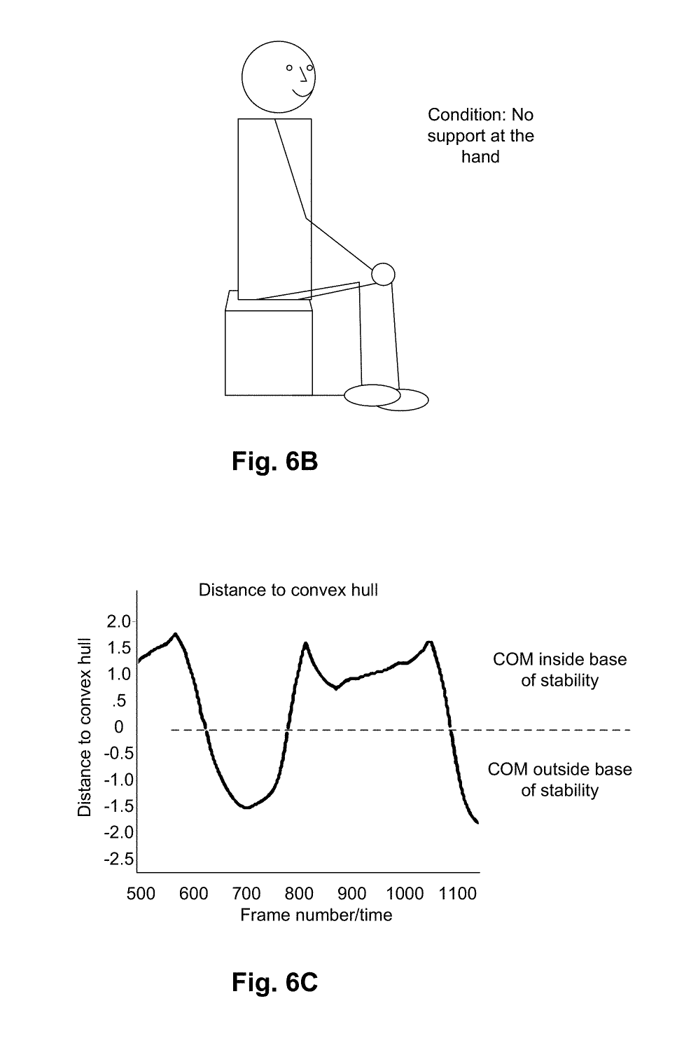

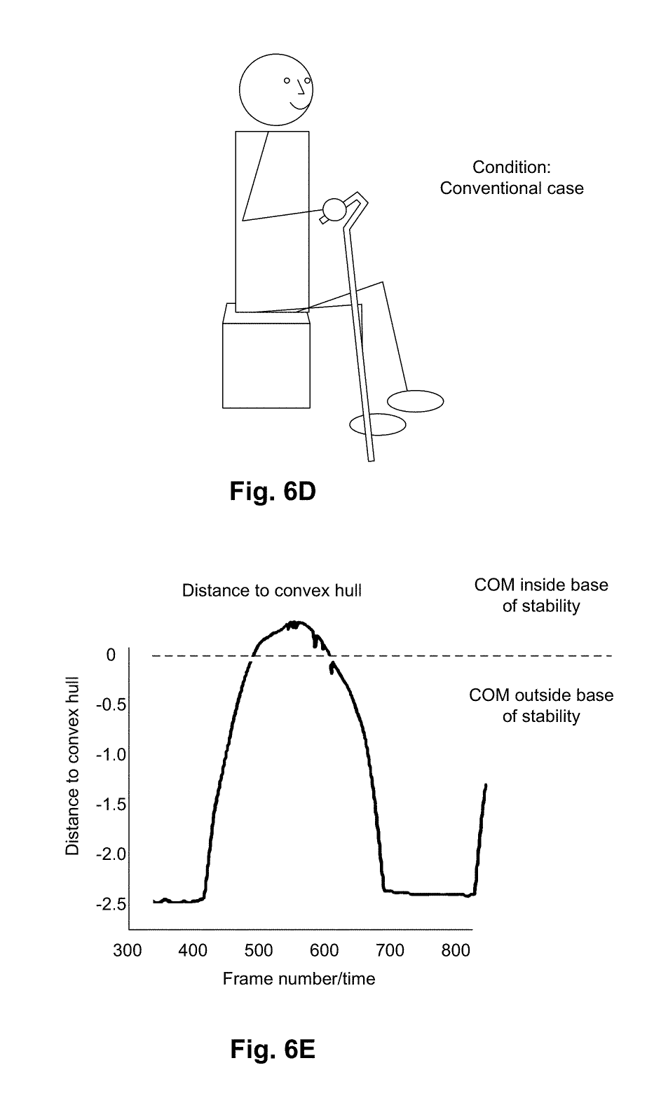

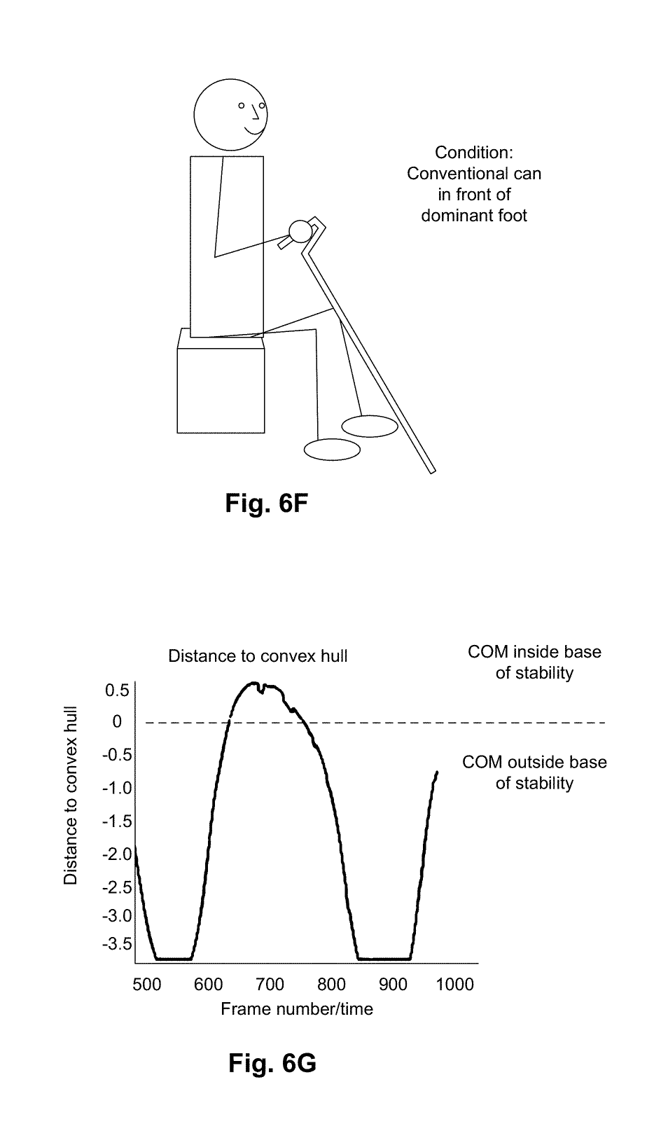

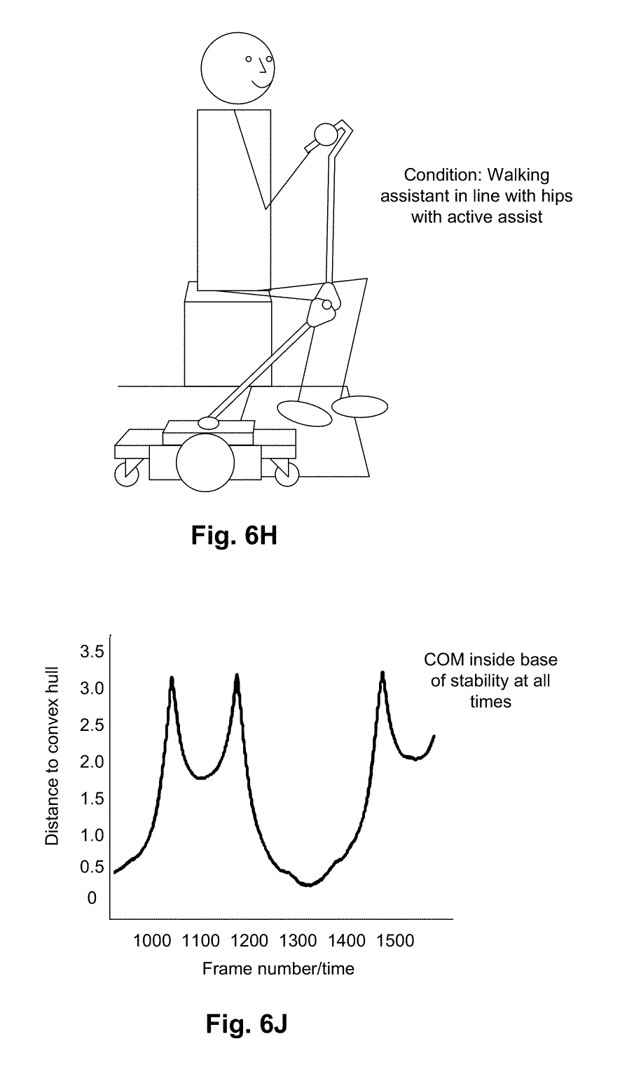

Compared to existing instrumented footwear, it measures a more complete set of intra- and inter-limb gait parameters. These include: stride length, foot-ground clearance, base of walking, foot trajectory, ankle plantar-dorsiflexion angle, cadence, single and double support, symmetry ratios, and walking speed. The device is fully portable and does not require any external equipment. SoleSound can optionally be combined with the robotic walking assistant to deliver auditory and vibrotactile feedback in response to the measured gait parameters and/or to provide information about the user's gait in order to provide support forces and directions responsively to the gait. Referring to FIGS. 6A′ and 6A momentarily, for example, if the user is repeatedly showing indications of imbalance, for example, as indicated by protected (greater than a stored threshold in the controller 111) periods where weight is placed asymmetrically or if the gait is erratic (falls outside a pattern range for normal gait in terms of wait sharing between feet) then the system be respond by providing greater pushing or pulling resistance through the motorized joint 156 in the robotic arm 152. Data can be gathered from SoleSound at around 500 Hz.

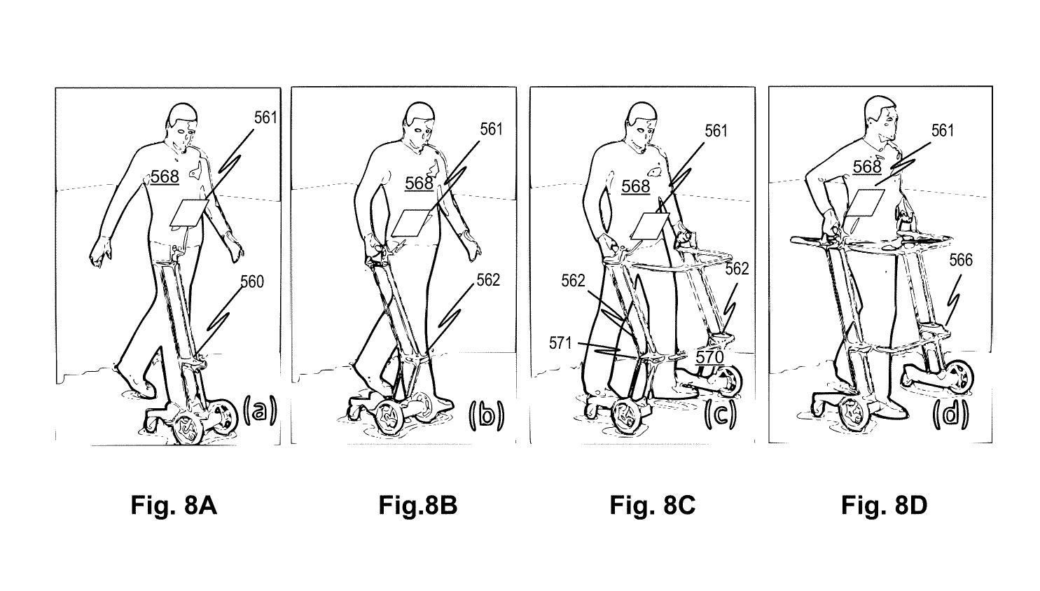

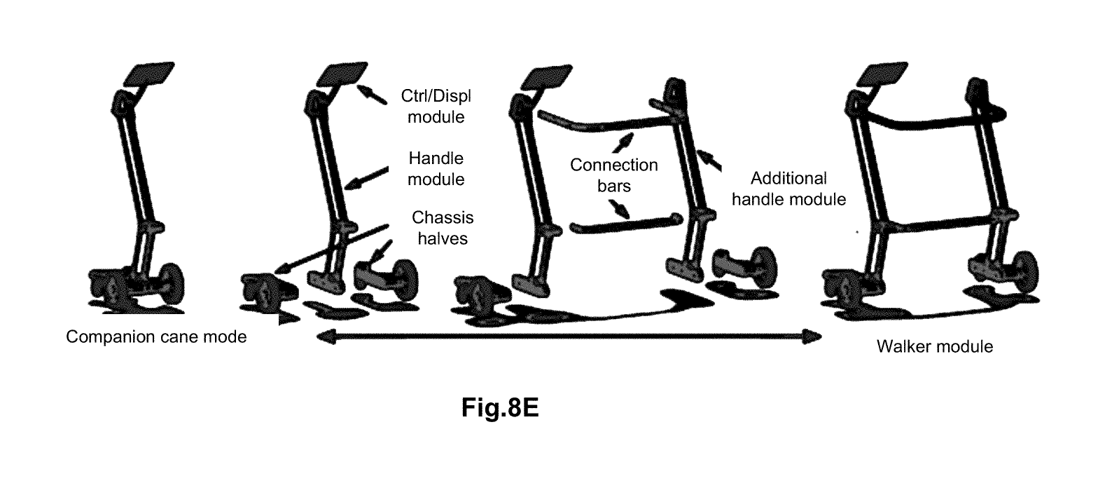

In the foregoing, the reference numerals of FIGS. 6A and 8D were used interchangeably and terms for parts were used so. The similarities and differences of the configurations of FIGS. 8B and modular components corresponding to the embodiment of FIG. 6A will be apparent by inspection. For example, the robotic arm 152 in each leg is a single rod while in the 8B embodiment, the equivalent is a parallelogram. Functionally, however, it will be apparent, they are very similar.

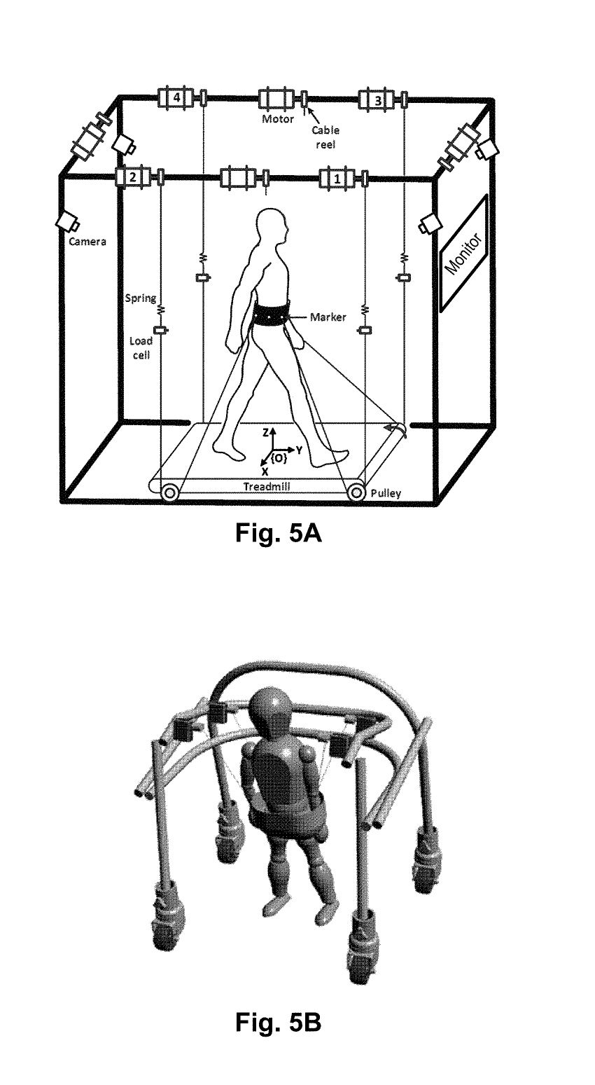

In FIG. 8D, a pelvic assist element is added to the disclosed walker. The details and control of the pelvic assist portion will be understood, in embodiments, from a previously published disclosure, namely, US Patent Application No. 20170027803 to Agrawal, et al, hereby incorporated by reference in its entirety herein. FIG. 5A shows a cable-driven system, called Tethered Pelvic Assist Device (TPAD) described in the foregoing reference. In this system, cables are attached to a 200-gram hip belt worn by the subject while walking on a treadmill. The figure shows four cables arranged in the horizontal plane passing through the human pelvis. This system is modular and can accommodate up to eight active cables. With eight cables, it can apply arbitrary forces and moments on the pelvis during walking. The system can currently provide controlled magnitudes of external forces and moments on the pelvis, either continuously or in short pulses, synchronized with gait events such as heel strike, toe off, and others. A motion capture system monitors the human configuration during walking and provides kinematic data to the real-time controller which then regulates the tensions as needed during the walking. Ground reaction forces are monitored during motion by force plates embedded in the treadmill and can be used as part of the controller as well to apply certain forces at specific instant of the gait cycle.

TPAD has been used in human experiments with cables configured in different directions to match the goals of the experiment. The experiments have involved both healthy young and older adults with various conditions including stroke, cerebral palsy, Parkinson's disease, and cerebral ataxia. Patients with cerebral palsy were crouch walkers and the intervention for them was to apply a force on the pelvis that was directed downwards. With training, they were able to strengthen their extensor muscles and were able to develop an erect posture. The experiments with stroke patients were designed to apply a force on the pelvis to push the center of mass directly above the supporting leg. This helped them to strengthen their weak leg. Older adults and patients with Parkinson's disease underwent experiments where perturbation pulses were applied on the pelvis in different directions randomly during heel strike. The results showed that both the elderly and patients with Parkinson's disease were able to improve their margin of stability during walking as a result of these interventions. These interventions and the observed human responses have helped us to characterize how humans maintain stability during walking and how the body center of mass is intrinsically regulated to be within the base of support.

FIG. 5B shows another cable-driven system, called Tethered Pelvic Assist Device (TPAD). This system is also disclosed in US20170027803 incorporated by reference above. In this system, cables are attached to a hip brace worn by the subject while walking on a treadmill. The schematic shows four cables arranged in the horizontal plane passing through the human pelvis. However, this system is modular and can accommodate up to eight active cables. These cables can be arranged to apply a general force and moment on the human pelvis during walking. The system can currently provide controlled magnitudes of external forces and moments on the pelvis, either continuously or in short pulses, synchronized with gait events such as heel strike, toe off, and others. A motion capture system monitors the human configuration during walking and provides kinematic data to the real-time controller which then regulates the tensions as needed during the experiment. Ground reaction forces are monitored during motion by force plates embedded in the treadmill and can be used as part of the controller as well to apply certain forces at specific instant of the gait cycle.

Referring now to FIGS. 6A and 6A′, among embodiments of the disclosed subject matter is a robotic walking assistant 148. The robotic walking assistant functions as (i) a companion during normal walking to autonomously follow a person on the side, and (ii) a powered cane with the goal to enhance balance during normal daily activity. A chassis 150 with two independently controlled powered wheels 160 are driven by motors 161 by a controller 111 about a common axis of rotation. Two passive caster wheels 162 on opposite sides of the chassis 150 maintain a horizontal orientation of the chassis 150. The system may be powered by a mobile power source such, for example storage battery, supercapacitor, or lithium polymer batteries (not shown).

A Wi-Fi-capable microprocessor (e.g., Particle Photon which was used in the described experiments) 165 wirelessly receives position and velocity data of a person moving in the environment. Position and velocity data may be acquired and transmitted by a variety of know devices, collectively indicated at 166, for example accelerometer, radio-triangulation, encoder-suits, and Vicon infrared tracking system, the latter having been used in the present experiments. It will be understood that options for position and velocity acquisition do not necessarily need to be performed by a separate device as suggested by 166 and may be transmitted to the walking assistant 148 by alternative means. For example, an accelerometer-based device that tracks multiple degrees of freedom can convey this information by wire. The microprocessor implements a procedure for person-following to control the motion of wheels. A two degree-of-freedom planar robotic arm 152 is strong and light weight, for example, bamboo, tubular aluminum or butted steel, or carbon fiber tubing. Servo motors on the joints 156 control joint angles. Other types of drives may be used, for example stepper motors. Each motor may have the capability of control either in position or torque mode. A force-torque sensor 163 is positioned at the handle 154 to indicate a force along the axis of the arm 152 top part and the torque thereabout. Other types of force sensing arrangements are also possible such as cartesian with a high number of degrees of freedom, pressure sensors on the handle 154 to detect the pressure of the user's hand. These types of force sensing arrangements can be resolved into equivalent signals for control using techniques known in the art.

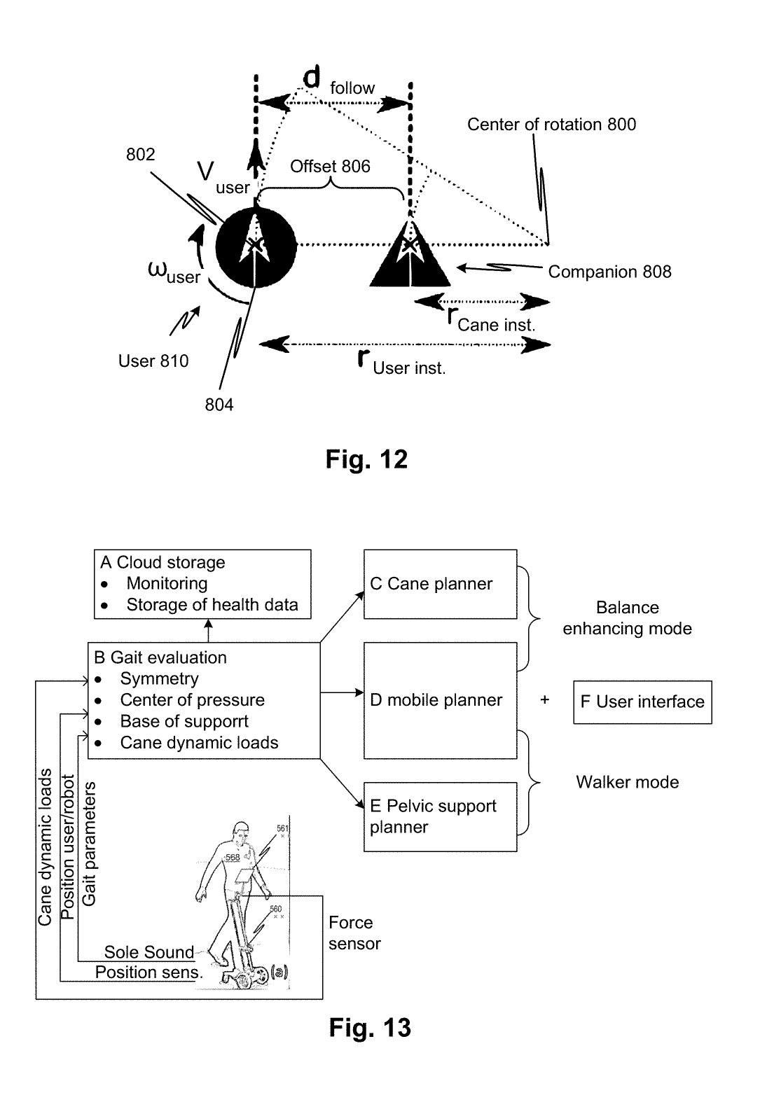

Referring to FIG. 12, a side-by-side autonomous following algorithm is illustrated as a schematic of a simple autonomous person and companion as they move as if they form a rigid body with an instantaneous center of rotation. In this algorithm, the human moves and the robot follow him. Thus, the human 568 and the robot companion 560 (See FIG. 8A) move together as if they form a rigid body with an instantaneous center of rotation 800. Given the planar translational speed of the pelvic center 802 of the user and rotational speed of the pelvis normal 804 to this plane, one can identify the instantaneous center of rotation 800. Once a desired offset 806 of the companion is chosen by the user, the controller computes an instantaneous translational velocity of the vehicle center. Its angular velocity stays the same as the user. Additionally, an error-based controller, for example implementing a path planning algorithm, may prevent the accumulation of error. An algorithm was simulated for a sinusoidal user trajectory and the results showed no error accumulation and close following behavior.

In embodiments, the companion may receive the parameters needed to implement this control algorithm from a Vicon camera system. As discussed elsewhere, other position and orientation systems may be used such as accelerometers attached to the user. Algorithm modifications must be made to account for sensor noise and delayed actuation, two significant challenges for real time person following.

Experiments relating to measure of stability during sit-to-stand are now described. A study was performed with healthy subjects to understand how the margin of stability changes under different conditions as a user stands up from a chair with and without support of a cane. The margin of stability may be defined as the smallest distance between the projection of the center of mass on the ground and the boundaries of support polygon, formed by the convex hull of the two feet and the cane on the ground. The margin of stability was measured by placing reflective markers on the human body (arms, legs, pelvis, and the trunk) and the cane which are tracked using a Vicon motion capture system. The experiment was performed under four different conditions, as shown schematically in FIGS. 6B through 6H and 6J. These conditions were: (i) The subject gets up from a chair without any support at the hand (FIGS. 6B and 6C), (ii) The subject uses a conventional cane with its handle adjusted to the pelvic height when standing. The foot of the cane is placed in line with the outer arch of the dominant foot (FIGS. 6D and 6E), (iii) The subject uses the same conventional cane in (ii), but placed in front of the dominant foot (FIGS. 6F and 6G), and (iv) The subject uses the walking assistant placed to the right in line with the hips and the grip handle height adjusts continuously to the height of the pelvic center during standing up (FIGS. 6H and 6J). FIGS. 6C, 6E, 6G, and 6J show the respective minimum distance of the center of mass (COM) to the base of support polygon for each of the conditions illustrated in FIGS. 6B, 6D, 6F, and 6H. This means that a value of 0 at time t indicates that the center of mass (COM) is lying on an edge of the support polygon.

The upper portions (labeled) of each graph show when the COM is outside the base of stability, while the lower portion of each graph represents when the COM is inside the base of stability except for the last case where the COM is always in the base of stability. For case (i), while sitting, the COM is outside the support polygon and the subject must accelerate the COM between the feet to enter the support polygon. For cases (ii) and (iii), the subject's COM enters the support polygon later in the transition from a seated to standing position. This could be due to having an extra point of support. The center of pressure under the feet needs to be studied to understand how the crutch changes the shift of weight while standing and the forces exerted on the cane. In case (iv), the COM is always contained within the support polygon. The center of pressure would also need to be studied as the interaction forces between the user and the intelligent cane changes.

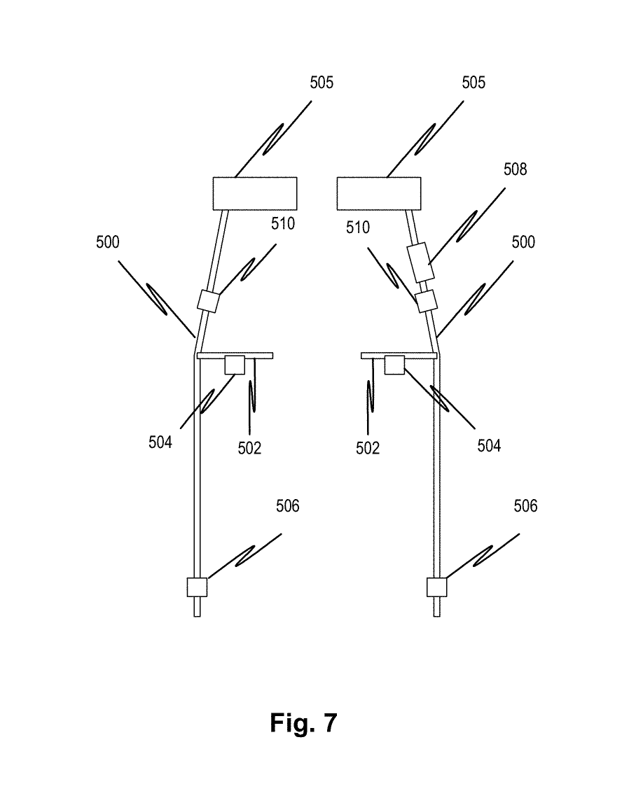

Referring to FIG. 7, instrumented forearm crutches 500 with upper arm supports 505 are shown. The crutches 500 have vibrotactile feedback transducers 504 attached to handles 502. The transducers 504 indicate to patients if they are distributing their weight improperly between their limbs and the crutches. Force transducers 506 in each crutch 500 generated signals provided to a controller processor 508. The force transducers may provide an indication of linear (axial) force or may indicate further degrees of freedom such as detection of traction forces in one or more axes. The controller 508 may communicate with both feedback transducers 504 which may generate an audio or tactile output, for example, a vibration. The crutches 500 provide a safe mechanism for monitoring and alerting the user if he is not distributing his weight bearing properly. The system is fully-portable and estimates 3D ground reaction forces at the tip of each crutch without relying on laboratory equipment such as force plates or a motion capture system. This allows the device to be used outside clinical laboratories. The instrument can help users appropriately modulate the amount of load applied to the legs during swing-through gait, three-point gait, and sit-to-stand using banded vibrotactile feedback.

The force transducers may include upper and lower portions in which one includes a load cell that measures the bending moment about two orthogonal axes while the other one measures axial forces. With point-contact between the crutch and the ground, these measurements are sufficient to estimate 3D ground reaction forces. The feedback transducers 504 may include small vibrating, next to or on the arm rest. An inertial measurement unit 510 enables estimation of the crutch orientation as well as the direction of the ground reaction forces. The latter may be used to compute the percentage of user's body weight (BW%) loaded on each crutch in real time by vector arithmetic. This percentage may be compared to a threshold stored in the controller 508 and determined thereby to fall within or outside an adjustable safe range. When falling outside the safe range, the vibrotactile cues (or other cues such as audio) are triggered. Different vibrating modes may be defined to inform the user if more weight or less weight should be applied on the crutch. For example, dash-dot, dot-dot, fast-slow, etc.

Another mobile robot configuration is shown in FIGS. 8A through 8D. The design is customizable to assist elderly people in their activities of daily life. The system may assist people with different levels of physical and/or cognitive impairments with minimal modifications to the basic hardware and software architecture. The support provided by the system may be both psychological, i.e., help the patients in the management of ADL, and physical, i.e., through a gait support device. The choice of the most appropriate assistive device may depend on the clinical features associated with the subject's motor abilities, cognitive functions, vision, vestibular functions, muscle tone and degenerative status of lower and upper limb joints.

The system may be customized based on the levels of physical and cognitive impairments. For example, users may be classified into five functional groups: (i) individuals who are able to ambulate independently but require cognitive supervision or physical assistance to walk on inclines or non-level surfaces, (ii) individuals who are physically able to ambulate without manual contact of another person but for safety reasons require standby assistants because of poor judgment, questionable cardiac status, or the need for verbal cuing to complete the task, (iii) individuals who require continuous or intermittent light touch to assist in balance and coordination, (iv) individuals who require continuous manual contact to support body weight as well as to maintain balance and coordination, (v) individuals who are unable to ambulate or require physical assistance from more than one person. The embodiments may serve each of these user groups with minimal modifications. This section outlines embodiments, a framework for planning and control for assistance and rehabilitation, and human evaluations in LTC care facilities.

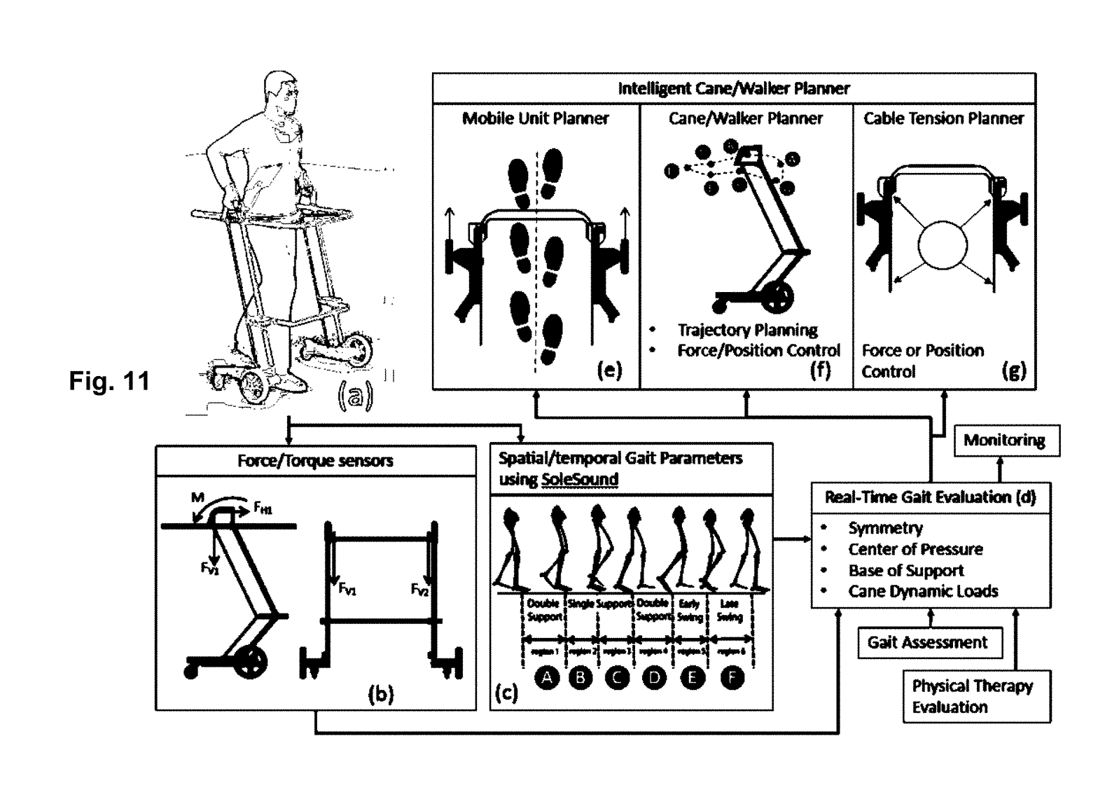

The modular walking assistant is customizable to take different forms to accommodate the specific needs of elderly users as—(a) a companion robot (FIG. 8A), (b) a balance enhancing cane (FIG. 8B), (c) a walker (FIG. 8C), or (d) a walker with active pelvic support (FIG. 8D). The simplest mode is the companion mode where a walking assistant 560 follows the user. In this mode, a computer interface with a display 561 on the device can be used for guidance and communication. In the cane mode FIG. 8B, the system may be programmed to provide soft touch or active balance support, for example as described with reference to the embodiment of FIG. 6A. If the user requires bilateral support to balance, the system may be reconfigured as a walker FIG. 8C by connecting two walking assistant modules by a cross-member. FIG. 8E illustrates how modules can be combined to create the configurations of FIGS. 8A through 8D. If in addition, the user needs active pelvic support during walking, a cable-driven TPAD-like system may be added to the walker as shown in FIG. 8D. A conceptual design of these systems, along with modular components, is shown in FIG. 11.

The ‘companion’ 560 and ‘balance enhancing cane’ 562 may include two wheeled modules, an articulated handle (See FIG. 6A), and a control/display 561 attached to the handle. Each wheel module may include one or more motors to actuate the drive wheels. One more caster wheels may be attached as in FIG. 6A or as indicated in FIGS. 8A and 8B attached to the back of a chassis to maintain orientation. The articulated handle includes a base at the bottom to connect to the wheel modules. A two-link active serial chain supports the handle. In these embodiments, unlike that of FIG. 6A, the serial chain may have parallelogram links so that its end-effector, which supports the handle and the display monitor, remains parallel to the ground. The serial chain is actuated by two motors attached to its joints to modulate the position of the handle relative to the base, in accordance with the user's height and to provide following forces when the patient raises or lowers his hand and/or body. In the present embodiments, and in the embodiments of FIG. 6A, the motors on the articulating joints may have brakes so that they do not have to be powered all the time or the drives may be of a self-locking type that lock naturally due to a high mechanical advantage and some friction in the transmission.

As indicated, the balancing cane 562, FIG. 8B, can be reconfigured into a ‘walker’ 570 by interconnecting two balancing canes 562 with two connection bars. The second handle may be identical to the first one. The controller may be shared by both and synchronize the movement of both handles. The joint drives 571 (which may be as the motorized joint 156 in the robotic arm, the term cane here being the equivalent of the robotic arm in respective embodiments) on the canes are used to position the handle of the cane or the walker at an ergonomic height relative to the user to provide support. They may also provide a selectable compliance sufficient to provide support but not stiff. The battery and electronics may be housed at the base of the handle to keep the center of mass of the system low with respect to the ground. This may help to avoid tipping of the overall system. The nonholonomic nature of the wheels, i.e., the ability to move instantaneously only along the direction of pointing of the wheels, makes the direction of the wheel axis naturally stiff along which forces can be applied to the user.

The control/display module 561 may include the main controller of the device as well as a screen to provide visual feedback to the user. The main controller may include a processor with computing capability to gather information from the sensors on the walking assistants and the human user. A pair of instrumented shoes (SoleSound) may be used as part of the control. The wheels and the handle may include their microcontrollers that may take commands from the main controller to drive their respective motors. A CAN bus may be used for real-time communication between the main controller and the microcontrollers. Data from touch sensors on the handles may enable the system to switch between the ‘companion’ and ‘cane’ modes. Torque sensors on the joints of the articulating handle may provide information on how much force the user applies to the handle. The device may be equipped with video cameras and/or LIDAR that monitor both the user as well as the surroundings. Through these sensors, the device determines the intended direction for the wheels and the height of the handles. Detailed planning and control algorithms are described in the following sections.

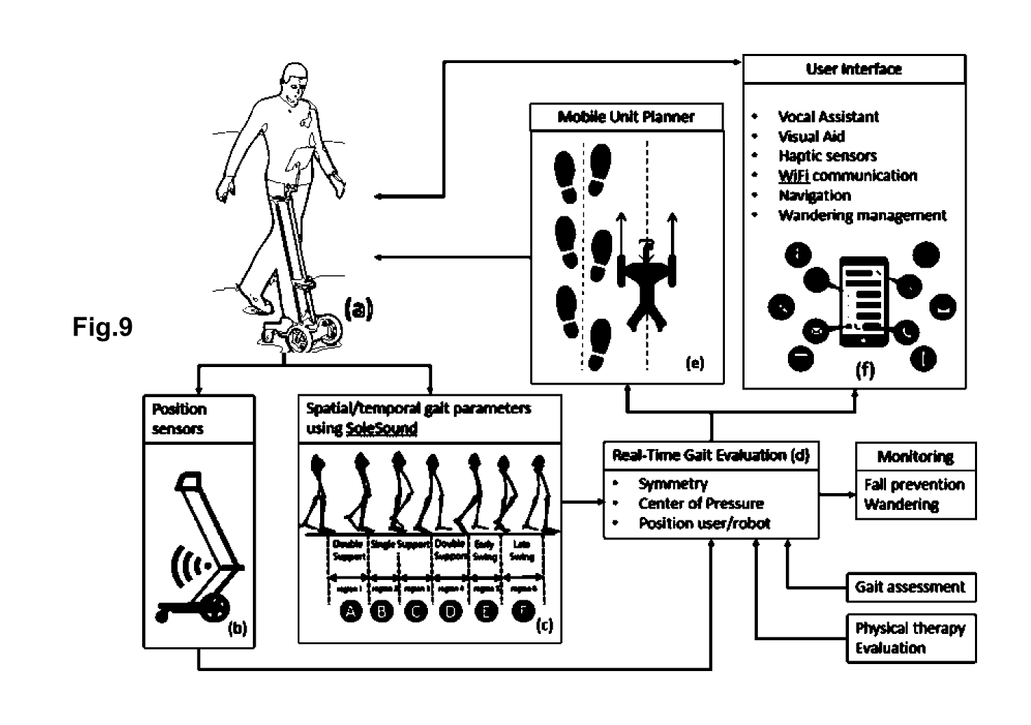

A Control Framework for Walking Companions may allow the companion to synchronize its movement with the user based on data from instrumented shoes such as SoleSound, body-worn sensors, and device mounted sensors. It may also act as a communication device to connect to others with walking assistants and a monitoring device for the caregivers. Using data from the instrumented shoes, as shown in FIG. 9, the ‘companion’ may monitor temporal and spatial parameters of the gait to predict early signs of mobility deficits and increased risk of falling. Necessary alerts to the user and caregivers may be generated based on these data. A schematic of the data flow between the sensors, communication, and control modules is outlined in FIG. 9. Machine learning may be applied to develop models using the large sensor data sets collected from the users. Machine learning algorithms may identify patterns in the data that to trigger special alerts for the users and/or caregivers. For example, patients with dementia often wander along the halls and pose risks to themselves. The long-term care center caregivers have to devote resources to monitor these patients and keep them safe. The sensor data may be used to automatically detect ‘wandering’ behavior of the users and provide alerts to the caregivers.

Referring to FIG. 9, a companion (a) may synchronize its movement with the user based on data from instrumented shoes, body worn sensors, and/or device mounted sensors (b, e). It may act as a communication device (f) for the user and a monitoring device for the caregivers (d). Using data from the instrumented shoes, the companion may monitor temporal and spatial parameters of the gait (c) and may provide necessary alerts to the user and caregivers (d). In addition, the data may be analyzed using principles of machine learning to identify anomalies and the forms of active support appropriate for the user.

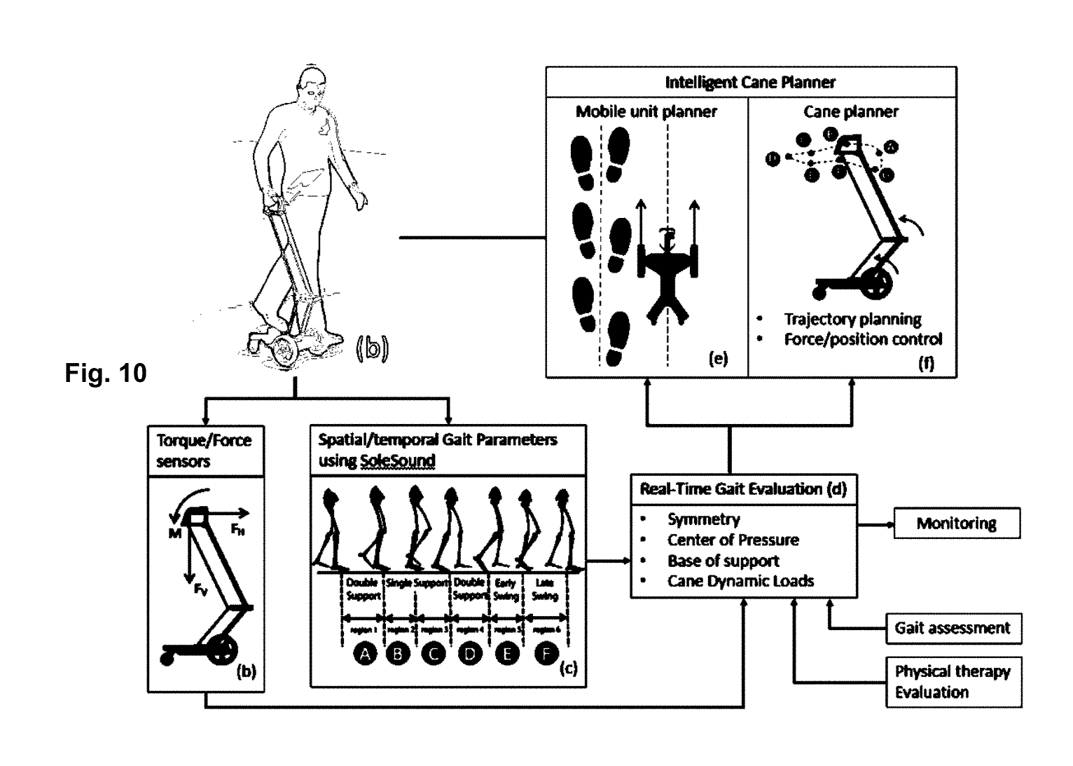

A control framework for balance-enhancing canes (FIG. 6A, FIG. 8B) as well as other embodiments may be provided through active regulation. Algorithms for balance-enhancing canes may be provided through active regulation of the center of pressure with respect to the instantaneous base of support. This can be accomplished in three ways: (i) relative positioning of the mobile base with respect to the human body to change the base of support, (ii) orienting the arm of the cane relative to the mobile base to encourage the user to adjust the body posture, thereby, the system center of mass, (iii) applying forces by the cane on the supporting hand to modulate the center of pressure. FIG. 10 shows the schematic of the overall sensing and control with balance enhancing cane.

The algorithms may use the following sensor data: instrumented shoes to measure the center of pressure of the human body in real-time, the body posture determined by body-worn sensors, and the interaction forces between the user and the can measured by the force sensors on the handle. The arm orientation of the cane may be determined using its joint sensors and the position and orientation of the mobile base using encoders on the wheels and IMUs mounted on it. The actuators on the arm of the cane may be used to apply appropriate forces on the user's hand (FIG. 10 (b)) during a gait cycle and/or change the position of the cane handle to actively modulate the human posture (FIG. 10 (f)). A fundamental principle in the algorithms for balance enhancing canes is active regulation of the center of pressure with respect to the instantaneous base of support. This may be accomplished by: (i) relative positioning of the mobile base with respect to the human body to change the base of support (e), (ii) orienting the arm of the cane relative to its base to encourage the user to adjust the body posture (f), (iii) forces applied by the cane on the supporting hand to modulate the center of pressure (b).

Real-time and reliable determination of the center of pressure and base of support may be determined through calibration or by trial and error. The cane or other device such as robotic walking assistant 148 may have destabilizing biomechanical effects on the user due to the inertia of the device and reaction forces/moments added to the user shoulder. This may perturb the center of mass and may require anticipatory postural adjustments. During the act of pushing the cane, the center of mass (COM) may fall towards the unsupported side reducing the Base of support (BOS). This may also require anticipatory postural adjustments. Unexpected balance perturbations could also arise if the device suddenly slips. These biomechanical aspects may be closely integrated within the control interface of the systems.

A Control Framework for the Walker and with Cable-driven Pelvic Support is similar to the cane mode with the walker controlling the motion of the mobile base, the supporting arm, and forces on the walker handle to regulate the center of pressure with respect to the base of support to augment stability. In addition, the motion of the mobile base, the supporting arm, and forces on the walker handle may be controlled to regulate the center of pressure with respect to the base of support to augment stability.

Referring to FIG. 11, aging is also associated with a reduction in the capability to generate appropriate ankle torque during push-off which affects toe clearance. Elderly persons often compensate for reduced ankle power with higher hip flexion power. This affects the elderly both biomechanically and energetically. Hip flexion assistance could be added to the pelvic supported walker to assist and train in forward swing phase. Conventional walkers are associated with a high risk of falling. Approximately, 87% of the injuries reported from falls, when using walking aids, are associated with walkers. Backward falls are particularly dangerous because these can result in serious, potentially fatal, traumatic brain injury. One could potentially address this problem by choice of appropriate cable configurations and monitor its impact on stability and falls of the users.

For the pelvic assist variation, the control of the walker may be similar to the cane to regulate the center of pressure with respect to the base of support to augment stability (e, f, g). In addition, for users with gait impairments, a cable-driven pelvic support system may be added (a), which may be used for in addition, gait/balance assistance, retraining, as well as for fall prevention. A pelvic brace may be worn by the user which may be controlled by up to eight servomotors mounted on the base of the walker and the control architecture may be similar to TPAD.

Safe and effective use of a cane or a walker during ambulation requires synchronizing device movement with the ongoing body movement. The user must also avoid contact of the walking aid with the lower limbs and with other objects in the environment. There is the need to control forces and moments applied to the device during movement or during loss of balance. These requirements place significant demands on the central nervous system (CNS) for attentional processing and neuro-motor control. The need to allocate cognitive resources to the control of mobility aid is challenging but can be trained through task experience. Older adults have reduced postural stability to respond rapidly to postural disturbance compared to young people. The training of neuro-motor control may be an important research question that may be investigated during rehabilitation.

The walking assistants may be networked with other walking assistants and personnel in the LTC facility. The disclosed embodiments may address issues that include (i) How to control the wheeled companion using sensed data from the user; (ii) How to control the wheeled mobile cane to facilitate and improve human balance; (iii) How to augment human balance using a walker with cable-driven pelvic assist device; (iv) How to continuously evaluate and improve the design with user inputs; (v) How to make these ubiquitous assistants for millions of elderly people.

The embodiments may be used for: (i) individuals who are able to ambulate independently but require supervision during walking due to cognitive decline, (ii) individuals who require intermittent manual assistance in balance and coordination, (iii) individuals who can walk but have substantial mobility impairments due to neurological conditions, e.g., stroke.

According to embodiments, a system is customizable to take different forms to accommodate the specific needs of a user as (a) a companion robot, (b) an intelligent cane, or (c) a walker with active pelvic interface. The simplest mode is the companion mode where the walking assistant follows the user. The device is used for guidance, monitoring, and communication. In the cane mode, the system can provide touch or active support to enhance balance. If the user needs active pelvic support during walking, this is provided in the third mode.

The ‘companion’ and ‘intelligent cane’ consist of a wheel base, an articulated handle, and a control/display. Each wheel module includes motors to actuate the drive wheels. A tested embodiment used two drive wheels and passive caster wheels for stability. Future designs will also explore holonomic wheel bases. An articulated handle has a serial chain with two motors. Future designs will explore a chain with additional degrees-of-freedom to position and orient the handle in a desired way relative to the user. Two intelligent canes can be reconfigured into a walker by adding connection bars. The battery, data acquisition units, and computational electronics may be housed at the wheel base to keep the center of mass of the system low to the ground. The display will include a screen for communication and user feedback. The system will receive information from the sensors on the walking assistant and the human user. The walking assistants will coordinate their movements with respect to the user based on data from instrumented shoes, body worn sensors, and device sensors. SoleSound may be used to monitor temporal and spatial parameters of the user's gait. These data may be used to program and test different behaviors for human assistance and rehabilitation. The specifics of the three modes, research questions, and human evaluations are discussed in the following sections.

Referring to FIG. 10, the walking assistant may synchronize its movement with the user based on data from SoleSound, body worn sensors, and/or device mounted sensors. (B) This gait data may be evaluated and used for control of (F) a user interface in combination with: (D) a robotic companion, (C) an intelligent cane for balance enhancement, and (E) a pelvic supporting walker for assistance and rehabilitation. Gait data will also (A) be stored in the cloud to inform the user, caregivers and the user's primary care physician about the user's health and mobility.

The various assistive configurations may control using data summarized in FIG. 13 and the data may be used for analysis and characterization of the performance characteristics.

A companion can synchronize its movement with the user based on data from instrumented shoes, body-worn sensors such as IMUs, and device mounted sensors. Rich movement and behavioral data may be collected and analyzed. Summary information may be provided to the user, the user's support personnel, and the user's primary care physician about mobility and function.

In example applications, a user, in mid-stages of Alzheimer's disease, may take a walk within the grounds of a living facility. The user or a caretaker may select a desired walking path and distance on the companion embodiment's screen. The companion will then act as a guide—leading the user along the path while communicating and displaying information, as needed. Proximity and range sensors on the companion could complement body-worn sensors, including SoleSound. These sensors could measure and interpret movement and balance. The movement patterns could be analyzed for indications of wandering and cognitive decline. Appropriate feedback and alerts could be given to the user and monitoring personnel within the living facility. Data collected over a longer course of weeks could be analyzed to assess trends in decline of balance and control to facilitate detection of disease milestones.

The sensing methods may detect user position relative to the companion using combined data from LIDAR, SoleSound, and body-mounted IMUs. These methods may be extended to estimate relative foot position within the base of support. An Extended Kalman Filter and kinematic biomechanical model approach utilizing data from SoleSound and from the companion's position sensors, allows an estimate of base of support. The base of support may provide real-time application of forces for gait modification. LIDAR systems may be used to evaluate silhouette of people performing different tasks. These capabilities may be applied in a mobile companion. A mobile companion according to any of the embodiments may capture and classify body position or activity of a user to provide an additional or primary input for selecting an assistance mode. Machine learning methods, such as recurrent and convolutional neural networks, may be employed to classify movement patterns during walking, for example to discriminate normal and unusual or irregular movements.

Classification results may be used to improve systems and for research. These data may be used to document subject characteristics, evaluate how cognitive resources impact user performance, and assess patient predisposition to falls. The data may be used for preventive clinical choices such as gait training. Recurrent neural networks have been used with SoleSound data to accurately identify gait cycle events such as heel strike, toe-off, double support, and the swing phase. These methods may be expanded during the course of this project. In addition, interviews may be conducted with clinical care personnel to identify what data sets in different contexts are needed for documentation and clinical management of subjects.

Using the simple scenario of getting up from a chair, stability can be addressed during this activity using the intelligent cane in multiple ways. When using a conventional cane, the resting point of the cane on the ground is static resulting in unnatural handle orientation and body kinematics during sit-to-stand. With the intelligent cane, its mobile base could be controlled during the transition from sit to stand to modify the user's base of support favorably. In conjunction, the position and orientation of the handle could be adapted to enable the user to modulate the posture while standing. The actuated joints in the cane could also be controlled to apply a desired force on the user's hand while gripping the handle. Anterior-posterior and medial-lateral forces can modulate the user's posture and center of pressure on the base. While walking, each of these methods can be adapted individually or in combination with others to improve the overall stability of the user.

The experiments that measured the body configuration during sit-to-stand motion for able bodied subjects was described above used Vicon motion capture system and reflective markers on the human body and the cane. This procedure allowed the computation of the base of support and the center of mass of the system. Other embodiments are possible. For example, pressure mats, force plates, and instrumented shoes, accelerometers, video camera with video-recognition systems such as used for security surveillance may also be employed. For example, processing image streams from one or more cameras in the assistant device may be enough to provide sufficient discriminating power to distinguish the relevant conditions. Radio transponders worn by the user may permit the user's body configuration by triangulation. In the above example, such as a floor mat, the examples can be used to measure ground reaction forces and the center of pressure. It should also be clear that procedures for support may include modulating the wheel base or force control on the cane handle.

In embodiments, the center of pressure is actively measured in real-time and modulated to improve the stability. In the sit-stand experiment, only the vertical height of the handle was controlled while sensing the user's pelvic height. Other algorithms that utilize anterior and posterior pelvis motion may employed. Force field guidance, published in earlier patent applications and academic publications, is staple method for providing assist-as-needed assistive strategies in movement training and may be employed to form additional embodiments. For example, as indicated above, the motors may be used to provide variably-compliance support to a user based on the detected movement, body position, or action being taken.

Patients with stroke often have one-sided gait deficits, called hemiparesis. They walk asymmetrically and avoid loading the weak leg. Due to lack of use, over time the muscles in the weak leg further deteriorate. Many stroke patients undergo physical therapy in the clinic. Training programs have been proven successful if they include motor learning principles such as task repetition and task variability. Experiments have demonstrated effective gait retraining strategies in stroke patients using robotic exoskeletons for example, TPAD. TPAD may apply forces on the pelvis during the gait cycle when only the weak leg is in contact with the ground. This shifts the COM closer to the weak leg, strengthening the muscles over time. This fundamental control principle can be implemented by the intelligent walking assistant with the pelvic interface.

Currently, gait training and rehabilitation is performed in specialized clinics and rehabilitation centers. This fact, coupled with travel and time restrictions, limits patients' access to rehabilitation equipment and personnel. This not only limits the quantity of training sessions, but also the translation to daily activities. The intelligent walker, with active pelvic interface, could potentially provide unlimited access to an ‘over ground’ gait trainer. In embodiments, the disclosed methodology may be applied to stroke patients with hemiparesis and may further be extended with suitable control methods for patients with weakness in both legs.

In TPAD, certain control algorithms change the length of cables tethering the subject's pelvis to a fixed inertial frame while the subject walked on a treadmill. Providing assistive and/or training forces over ground using a mobile base may employ further algorithms to control of the walker base and determine the pelvis location and orientation relative to the moving coordinate frame of the walker.

The characterization of spatial and temporal gait parameters during normal walking and other activities in daily life is provided by SoleSound. Removable soft insert insoles may be provided to allow for data collection from individuals during walking and other daily activities. Data from SoleSound may be combined with data captured from a motion capture system and/or an instrumented gait mat to enhance therapies. Forces may be applied to each subject's pelvis to impact the gait.

According to embodiments, the disclosed subject matter includes a mobile assistance platform. A chassis with supported on motorized wheels. Hand grips are connected to the chassis by a linkage that permits the handles to move closer or further from the chassis. The chassis, hand grips, and linkage may have the general form of a walker. The chassis, hand grips, and linkage may have the general form of a crutch. The chassis, hand grips, and linkage may have the general form of a cane. The linkage may include a pair of parallelogram linkages.

The parallelogram linkages may be releasably locked together. The release of the selective separation of the parallelogram linkages may permit a single parallelogram linkage to be used independently of the other as a separate chassis with a single linkage and functions as a cane. The embodiments may include a graphical computer display. The embodiments may include a controller that actively controls the wheels to maintain stability of a user. The controller may execute a learning algorithm. The embodiments may include a brace that is shaped and sized to be worn around the hips of the user. The brace may be attached to the platform by cables. The cables may be actively controlled by servo-motors. The embodiments may in include an optical scanning system that calculates the surrounding obstacles. The optical scanning system may include LIDAR. The parallelogram linkages may be actively controlled by a controller. The parallelogram linkages may be actively controlled by a controller and servo-motors.

Embodiments may include a system using any of the above platforms and a pair of shoes with sensors, the sensors sending signals responsive to pressure on the shoes from walking to a controller of the platform, the platform wheels being actively controlled responsively to the signals. Any of the foregoing embodiments may include a pair of shoes with sensors, the sensors sending signals responsive to pressure on the shoes from walking to a controller of the platform, the brace being actively controlled responsively to the signals. An on-board controller may store data from the recited motors and sensors. The system or platform of any foregoing claim, wherein a controller executes an algorithm that optimizes a relative position of a center of pressure indicated by sensors in the platform and a base of support. A numerical representation of the location and size of the base of support may be stored in the controller. The sensors may be located in the handles of the platform.

It may be appreciated that the modules, processes, systems, and sections described above can be implemented in hardware, hardware programmed by software, software instruction stored on a non-transitory computer readable medium or a combination of the above. For example, a method for assisting walking can be implemented, for example, using a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, Lab VIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of control systems, machine intelligence, kinematic design and/or computer programming arts.

Moreover, embodiments of the disclosed method, system, and computer program product can be implemented in software executed on a programmed general-purpose computer, a special purpose computer, a microprocessor, or the like.

It is, thus, apparent that there is provided, in accordance with the present disclosure, mobility assistant devices methods and systems. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

What is claimed is:

1. A mobile assistant platform for helping patients with movement disabilities, comprising:
a robotic vehicle connected to a two-link arm, the arm having a handle at height suitable for a walking cane and movable by means of said two-link arm, to multiple heights in a range around said height suitable for a walking cane;
a digital processor connected to the robotic vehicle to control it;
at least one force sensor in the handle and/or two-link arm connected to apply force signals the digital processor;
a user-position and orientation detecting device connected to apply configuration signals to the robotic vehicle, the user-position and orientation detecting device being physically connected to one or more of the robotic vehicle, a region outside the robotic vehicle, or on the user, alone or in combination, optionally also to the user depending on the processor being programmed to cause the vehicle to follow the user along a path that maintains a fixed distance from the user.

2. The assistant of claim 1, wherein the robotic vehicle has a motorized joint.

3. The assistant of claim 1, wherein the two-link arm has a motorized joint.

4. The assistant of claim 1, wherein the robotic vehicle is steerable by means of differential wheel rotation.

5. The assistant of claim 1, further comprising a user interface connected to the handle.

6. A mobile assistant platform for helping patients with movement disabilities, comprising:
a robotic vehicle connected to a two-link arm, the arm having a handle at height suitable for a walking cane and movable by means of said two-link arm, to multiple heights in a range around said height suitable for a walking cane;
a digital processor connected to the robotic vehicle to control it;
at least one force sensor in the handle and/or two-link arm connected to apply force signals the digital processor;
a user-position and orientation detecting device connected to apply configuration signals to the robotic vehicle, the user-position and orientation detecting device being physically connected to one or more of the robotic vehicle, a region outside the robotic vehicle, or on the user, alone or in combination, optionally also to the user depending on the processor being programmed to cause the vehicle to position and move itself responsively to the position, motion, gait, and/or orientation of the user.

7. The assistant of claim 6, wherein the robotic vehicle has a motorized joint controlled by the processor to apply selected forces to the handle responsively to the position, motion, gait, and/or orientation of the user.

8. The assistant of claim 6, wherein the two-link arm has a motorized joint controlled by the processor to apply selected forces to the handle responsively to the position, motion, gait, and/or orientation of the user.

9. The assistant of claim 6, wherein the robotic vehicle is steerable by means of differential wheel rotation.

10. The assistant of claim 6, further comprising a user interface connected to the handle.

11. The assistant of claim 6, wherein the user-position and orientation detecting device includes a pair of instrumented shoes that transmit pressure signals indicating a gait of a user, the processor being programmed to control the two-link arm responsively to the pressure signals.

12. The assistant of claim 6, wherein the user-position and orientation detecting device includes a pair of instrumented shoes that transmit accelerometer signals indicating a gait of a user, the processor being programmed to control the two-link arm responsively to the accelerometer signals.

13. The assistant of claim 6, wherein the processor is programmed to cause the robotic vehicle to navigate a predefined course.

14. The assistant of claim 6, wherein the at least one force sensor includes force and torque sensors on the two-link arm.

15. The assistant of claim 6, wherein the e at least one force sensor includes force and torque sensors on the two-link arm located near said handle.

16. The assistant of claim 7, wherein the user-position and orientation detecting device includes a pair of instrumented shoes that transmit pressure signals indicating a gait of a user, the processor being programmed to control the two-link arm responsively to the pressure signals.

17. The assistant of claim 7, wherein the user-position and orientation detecting device includes a pair of instrumented shoes that transmit accelerometer signals indicating a gait of a user, the processor being programmed to control the two-link arm responsively to the accelerometer signals.

18. The assistant of claim 8, wherein the user-position and orientation detecting device includes a pair of instrumented shoes that transmit pressure signals indicating a gait of a user, the processor being programmed to control the two-link arm responsively to the pressure signals.

19. The assistant of claim 8, wherein the user-position and orientation detecting device includes a pair of instrumented shoes that transmit accelerometer signals indicating a gait of a user, the processor being programmed to control the two-link arm responsively to the accelerometer signals.
